(19) United States
(12) Patent Application Publication
(10) Pub. No.: US 2024/0344768 A1
(43) Pub. Date: Oct. 17, 2024

(54) SCRAP METAL FURNACE EVAPORATIVE COOLING SYSTEM

(71) Applicant: GPRE IP, LLC, St. Louis, MO (US)

(72) Inventors: John M. Peterman, Troy, MO (US); Bruce S. Miller, Wyncote, MO (US)

(73) Assignee: GPRE IP, LLC, St. Louis, MO (US)

(21) Appl. No.: 18/633,889

(22) Filed: Apr. 12, 2024

Related U.S. Application Data
(60) Provisional application No. 63/458,821, filed on Apr. 12, 2023.

(51) Int. Cl. F27B 7/38; F27B 7/18; F27D 9/00; F27D 21/00

(52) U.S. Cl. CPC F27B 7/38; F27B 7/18; F27D 21/0014; F27D 2009/0016; F27M 2001/10

(57) ABSTRACT

An evaporative cooling system for a scrap metal furnace with an afterburner, a rotary kiln and a conveyor that loads scrap metal into the kiln. Pressurized water runs through water lines to two water spray subassemblies. The first subassembly sprays atomized water into a heating duct between the afterburner and a gas recycle return duct. The second subassembly sprays water onto the scrap metal on the conveyor. Water flow through the subassemblies is regulated by one or more water flow controllers, pumps and/or flow sensors, which may be computer controlled. A water heater warms the water to a desired temperature.

### CROSS REFERENCE TO RELATED APPLICATIONS

This application derives and claims priority from U.S. provisional application 63/458,821, filed Apr. 12, 2023, and having Attorney Docket No. GILP H009US, which provisional application is incorporated herein by reference.

### STATEMENT REGARDING FEDERALLY SPONSORED RESEARCH OR DEVELOPMENT

Not applicable.

### BACKGROUND OF THE INVENTION

This invention relates principally to a system for controllably cooling a delacquering rotary kiln of a scrap metal recycling furnace, and more particularly to a system for the controlled injection of a water spray into one or more desired zones of a scrap Aluminum recycling furnace to help modulate the temperatures in the furnace's rotary kiln.

It has for some time been a standard practice to recycle scrap metals, and in particular scrap Aluminum. Various furnace and kiln systems exist that are designed to recycle and recover aluminum from various sources of scrap, such as used beverage cans (“UBC”), siding, windows and door frames, etc. One of the first steps in these processes is to use a rotary kiln to volatize and remove the paints, oils, and other surface materials (i.e., volatile organic compounds or “VOC's”) on the coated scrap Aluminum (i.e., “feed material”). This is commonly known in the industry as “delacquering.” Delacquering is typically performed in a chamber with an atmosphere having reduced Oxygen levels and with temperatures in excess of 900 degrees Fahrenheit. However, the temperature range at which the paints and oils and other surface materials are released from the aluminum scrap in the form of unburned volatile gases typically ranges between 450 and 600 degrees Fahrenheit, which is generally known as the “volatilization point” or “VOL.” The delacquering or volatizing chamber may be run as hot as 900-1000 degrees Fahrenheit to ensure that sufficient heat is transferred throughout the scrap load to achieve an internal temperature of at least 450 degrees Fahrenheit.

One of the difficulties encountered in operating a delacquering recycle furnace having a rotary kiln is control over the temperature in the kiln itself as the scrap metal is moving through the rotating kiln.

Unfortunately, fires can occur in the kiln when the feed material reaches the volatilization point too rapidly and the feed material begins to rapidly oxidize and generate its own heat, leading to a high temperature excursion (i.e., “overtemp event”). These overtemp events can occur at different positions along the length of the feed material in the kiln, and may be affected by such variables as the size of the feed material put into the kiln, the moisture content of the feed material, the volume of the feed material and the feed rate, the composition of the feed material, and the cleanliness of feed material. Applicants have learned through tests, utilizing, e.g., wireless high temperature thermocouples placed in the kiln, that such events can arise in as little as 10 minutes of operation. Further, Applicants have also learned that controlling the heat and moisture flow into the kiln can regulate and prevent such overtemp events. A fire in a rotary aluminum kiln can require a costly shut-down, will likely destroy the feed material, and can even damage the kiln and other associated equipment.

It would therefore be desirable to have an apparatus or system for a scrap metal recycling rotary kiln furnace that could provide further regulation of the temperature and/or moisture content in the rotary kiln to enhance the operational control of the kiln and also to minimize the risk of an overtempt event. As will become evident in this disclosure, the present invention provides such benefits over the existing art.

### BRIEF DESCRIPTION OF THE DRAWINGS

The illustrative embodiments of the present invention are shown in the following drawings which form a part of the specification:

FIG. 1 is a side view of a scrap Aluminum delacquering furnace with a rotary volatizing kiln, having incorporated in said furnace a first embodiment of the evaporative cooling system of the present invention;

FIG. 2 is a top plan view of the scrap Aluminum delacquering furnace of FIG. 1;

FIG. 3 is a front end view of the scrap Aluminum delacquering furnace of FIG. 1;

FIG. 4 is a rear end view of the scrap Aluminum delacquering furnace of FIG. 1;

FIG. 5A is partial cross-sectional side view of an upper portion of the feed conveyor of the scrap Aluminum delacquering furnace of FIG. 1, said upper portion having water piping and spray injectors of said evaporative cooling system;

FIG. 5B is partial cross-sectional rear view of the upper portion of the feed conveyor of FIG. 5A;

FIG. 5C is top plan view of the upper portion of the feed conveyor of FIG. 5A;

FIG. 6A is a partial schematic top plan view of the water piping and spray injectors for the upper portion of the scrap Aluminum delacquering furnace of FIG. 5A;

FIG. 6B is a cross-sectional partial schematic side view of the water piping and spray injectors of FIG. 6A;

FIG. 6C is an alternate cross-sectional partial schematic side view of the water piping and spray injectors of FIG. 6A;

FIG. 6D is a side elevational cross-sectional partial schematic side view of the water piping and spray injectors of FIG. 6A;

FIG. 7A is a partial cross-sectional bottom plan view of the lower frame portion for the water piping and spray injectors for the upper portion of the scrap Aluminum delacquering furnace of FIG. 5A;

FIG. 7B is a partial cross-sectional side view of the lower frame portion of FIG. 7A;

FIG. 7C is a partial cross-sectional top plan view of the upper frame portion for the water piping and spray injectors for the upper portion of the scrap Aluminum delacquering furnace of FIG. 5A;

FIG. 7D is a partial cross-sectional top plan view of a side frame portion for the water piping and spray injectors of FIG. 5A;

FIG. 8A is a partial cross-sectional top plan view of the upper framing and the water piping and spray injectors for the upper portion of the scrap Aluminum delacquering furnace of FIG. 5A;

FIG. 8B is a partial cross-sectional front view of FIG. 8A;

FIG. 8C is a partial cross-sectional side view of FIG. 8A;

FIG. 9A is an isolated plan view of the water piping and spray injectors for one of the injectors for the upper portion of the scrap Aluminum delacquering furnace of FIG. 5A;

FIG. 9B is a front view of FIG. 9A;

FIG. 9C is an opposing rear view of FIG. 9A;

FIG. 10 is a schematic diagram of an embodiment of the evaporative cooling system of the present disclosure;

FIG. 11 is a diagrammatic flow chart for a scrap metal delacquering furnace that incorporates one representative embodiment of the evaporative cooling system of the present disclosure, the chart depicting representative operational values for various components of the furnace depicted on the chart;

FIG. 12 is a diagrammatic flow chart for the scrap metal delacquering furnace of FIG. 11, but that incorporates a different representative embodiment of the evaporative cooling system of the present disclosure, the chart depicting representative operational values for various components of the furnace depicted on the chart;

Corresponding reference characters indicate corresponding parts throughout the several views of the drawings.

### DETAILED DESCRIPTION

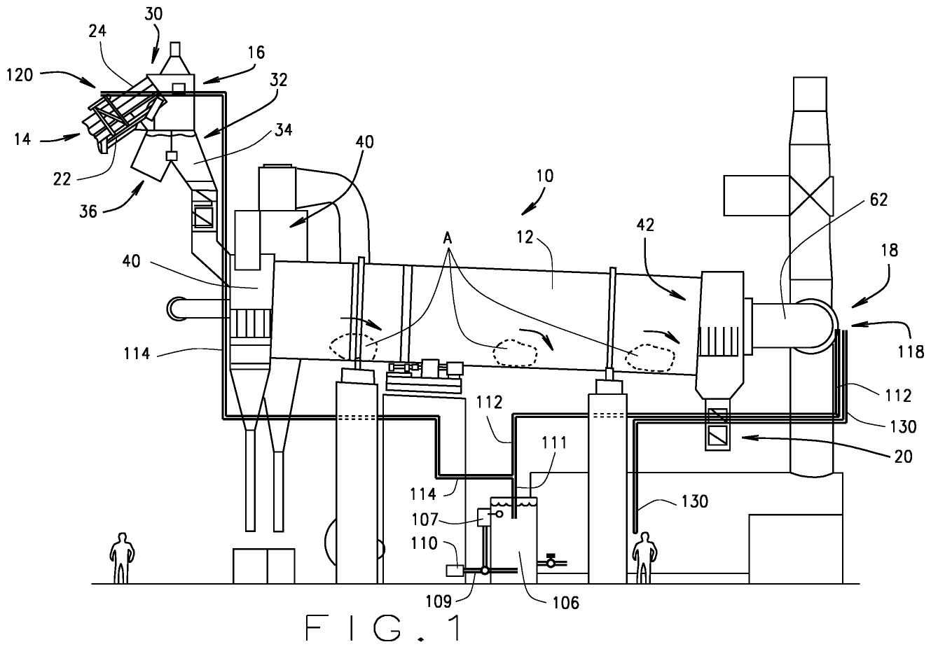

In referring to the drawings, a representative embodiment of a scrap Aluminum delacquering furnace 10 is shown generally in FIGS. 1-4, where the novel evaporative cooling system 100 of the present invention is depicted by way of example as incorporated into the furnace 10. The representative furnace 10 includes a delacquering rotary kiln 12, a material feed conveyor 14, a material feed chute 16, a recycling burner subassembly 18, and a discharge chute 20. The material feed conveyor 14 includes an elongated conveyor belt 22 positioned in a metal conveyor housing 24.

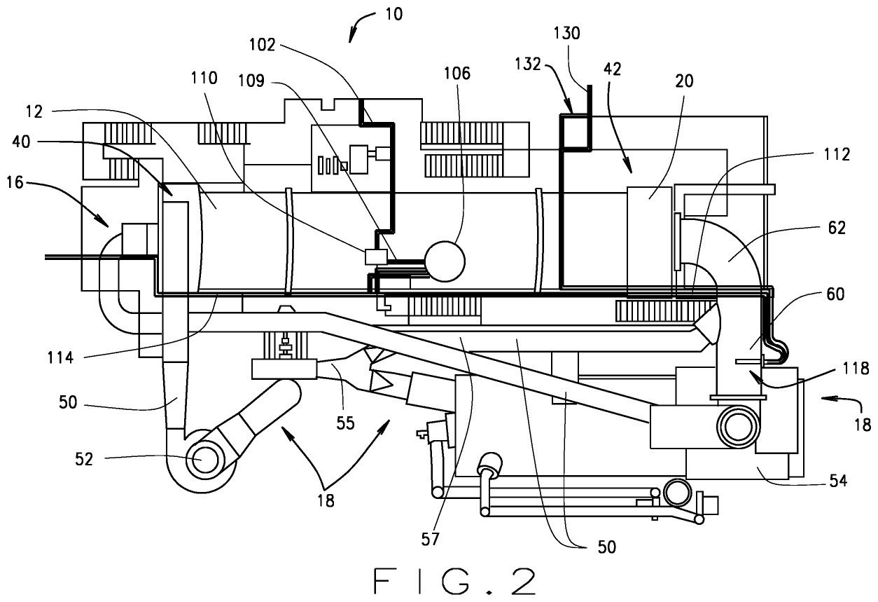

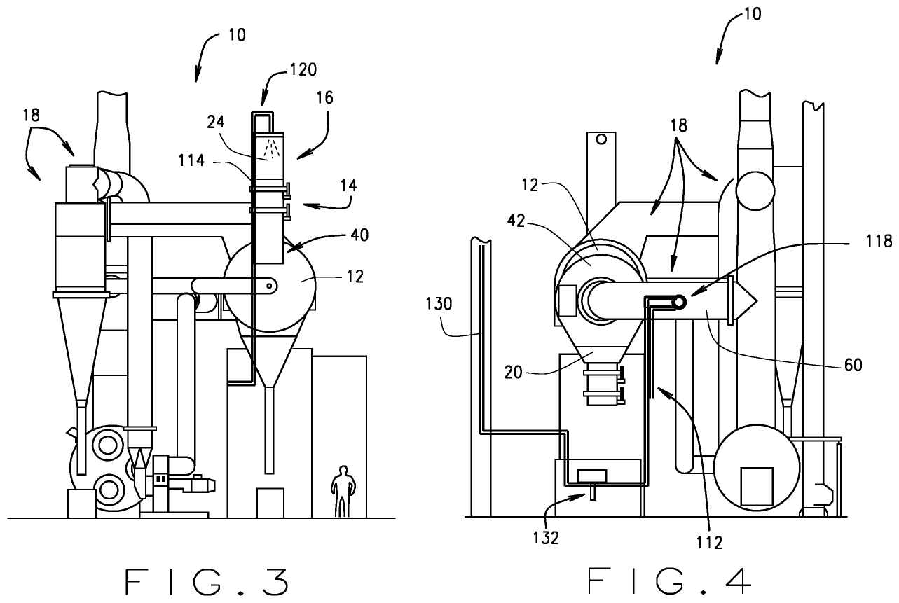

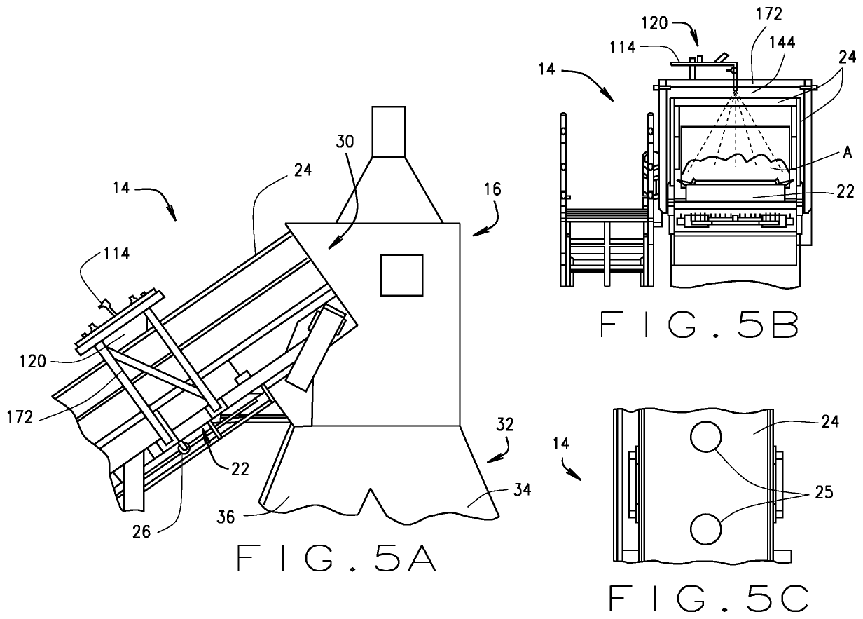

Referring now to FIGS. 5A-5C, the conveyor belt 22 can be anywhere from 5 to 10 feet wide and extends upward through the cover or housing 24 from ground level to the top of the feed chute 16, approximately 58 feet above ground level, at an angle of approximately 45 degrees. A series of equally spaced 12-inch diameter circular openings 25 run the length of the top surface of the housing 24. An electric motor and associated electronic controller (not shown) operatively control the conveyer belt 22 to travel on a set of metal rollers 26 spaced along the length of the conveyer 14, from ground level (not shown) to the upper end of the conveyor 14, and back again in circular manner. The material feed chute 16 is a gravity-fed enclosed funnel that has an inlet 30 at the top of the chute 16, which descends into a “pants” duct or divertor 32. The divertor 32 has a feed leg 34 and a discharge leg 36. The divertor 32 selectively allows desired portions of the scrap A to drop down through the feed leg 34 into the rotary kiln 12, or drop out of the furnace 10 through the discharge leg 36 (see FIG. 1). Referring to FIGS. 1 and 3, it can be seen that the rotary kiln 12 has a charge port 40 attached to the bottom of feed leg 34 of the divertor 32, and a discharge port 42 at the opposite end of the kiln 12 from the charge port 40 that opens into the discharge chute 20.

Referring now to FIG. 2, the recirculating burner subassembly 18, which is positioned generally along the length and side of the kiln 12, includes a collection of interconnected large diameter steel ducts 50, blowers 52, a hot gas generator or afterburner 54 along with various steel vents, and a diverter valve 55. Hot gases exiting the kiln 12 proximate the charge port 40 are directed and recirculated through various of the steel ducts 50 to the diverter valve 55. The diverter valve 55 is positioned inside one of the ducts 50, which has an automated control (not shown) associated with a computer control system for the delacquering furnace 10, that automatically controls the percentage of hot exhaust gases from the kiln 12 that are directed back through the afterburner 54 as opposed to the percentage that bypasses the afterburner 54 and is recirculated through a bypass duct 57 directly back into the kiln 12 proximate the discharge port 42. The exhaust gases that are directed into the afterburner 54 are heated further by the afterburner 54, while other hot gases are added to the mix by the operation of the afterburner 54. The re-heated exhaust gases with additional hot gases from the afterburner 54 are then directed through a steel duct 60, which joins with the bypass duct 57, to form a collective supply duct 62 that enters the kiln 12 proximate the discharge port 42.

As can be appreciated, the burner subassembly 18 generates fully or partially recirculated hot gases that are supplied to the kiln 12 to heat the scrap A in the kiln 12 as the scrap A tumbles down the kiln 12 from the charge port 40 to the discharge port 42.

Referring again to FIGS. 1-4 and 10, the evaporative cooling system 100 includes: a 2-inch water supply line 102, an inline water filter 104; a 1,190-gallon insulated, heated and vented water tank 106, a water level monitoring subassembly 107; a pair of regulated water heating elements 108 that automatically control the temperature of the water in the tank 106 to a predetermined level; a 2-inch water line 109 that originates from a booster water pump 110 and enters the near the base of the tank 106 to automatically control the flow rate of water exiting the tank 106; a 1-inch water line 111 that exits the tank 106 and splits into two 1-inch water lines 112 and 114. The water line 112 runs to the duct 60 of the burner subassembly 18; the water line 114 runs to the upper end of the conveyor 14; a heating duct atomizing water injector subassembly 118 positioned in the heating duct 60 that is operatively connected to the water line 112; and a conveyor spray subassembly 120 positioned at the top of the conveyor 14 that is operatively connected to the water line 114. The water level monitoring subassembly 107 automatically monitors and limits the amount of water in the tank 106 to a predetermined level by controlling the flow of water from the pump 110 into the tank 106. All of the water pipes/lines from the tank 106 onward (i.e., lines 109, 112 and 114) are insulated to maintain consistent temperature throughout the system 100. The cooling system 100 also includes a collection of various valves, sensors and regulators positioned throughout the system that are used to control and regulate the flow of water through the system 100. A water filter and bypass loop subassembly 124 is positioned along the water line 112.

In addition, the evaporative cooling system 100 includes a two-inch steel air supply line 130 that runs through a filter and bypass loop subassembly 132. The line 130 then runs through a pressure control subassembly 133 and then is connected to, and supplies pressurized air to, the heating duct atomizing water injector subassembly 118.

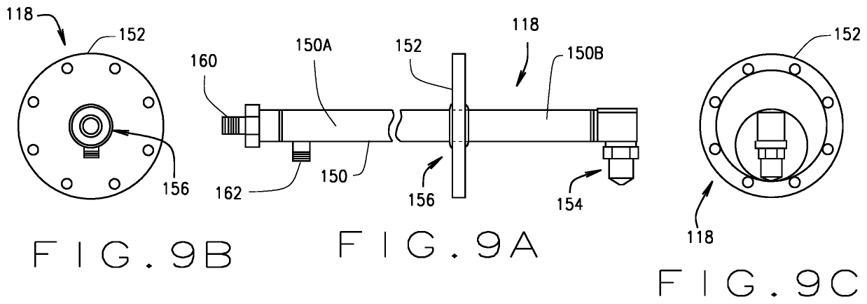

Referring to FIGS. 1, 2 and 4, it can be seen that the water line 112 extends from the water line 109 to the heating duct water injector subassembly 118 attached to and extending into the duct 60 of the burner subassembly 18—upstream of the duct 57. The injector subassembly 118 (FIGS. 9A-9C) includes a straight 1-inch steel outer pipe 150 that is approximately 40 inches long, a 1-inch-thick circular steel center flange 152 that is approximately 12 inches in diameter, and an atomizing injection nozzle 154. The pipe 150 extends through a through bore 156 in the center of the flange 152, where the flange 152 is secured to the pipe 150. An outer portion 150A of the pipe 150 extends outward from the flange 152 approximately 28 inches, and an inner portion 150B of the pipe 150 extends inward from the flange 152 approximately 12 inches.

The outer pipe portion 150A of the pipe 150 has a coaxial first nipple 160 at the end opposite the flange 152 and a downwardly-directed second nipple 162 near the first nipple 160. The first nipple 160 attaches to the pressurized air line 130 and the second nipple 162 attaches to the water line 112. The nozzle 154 attaches to the end of the inner portion 150B of the pipe 150 opposite the flange 152, and is directed downward from the pipe 150 at an angle of approximately 90 degrees. The nozzle 154 uses the water supplied by the line 112 with the pressurized air from the pipe 130 to dispense high pressure water in droplets of approximately 10 micron size into the duct 60.

The center flange 136 is bolted to the side of the duct 60 of the burner subassembly 18 over an opening in the side of the duct near the top of the duct that is sized to receive the inner pipe 132. The injector subassembly 118 is attached such that the inner portion 150B of the pipe 150 and the nipple 154 fully extend horizontally extend into the duct 60, and oriented such that the nipple 154 is pointed downward. The outer portion 150A of the pipe 150 extends horizontally away from the side of the duct 60.

Referring now to FIGS. 1-4, 5A-C, 6A-E, 7A-D, and 8A-C, it can be seen that the water line 114 extends from the water line 109 to the water spray subassembly 120 attached to the upper end of the conveyor 14. The spray subassembly 120 (FIGS. 5A-C, 6A-E, 7A-D, and 8A-C) includes a rectangular steel framework 172 that is positioned generally above, and attached to, the upper end of the conveyor 14 over the housing 24. The water line 114 runs along one side of, and extends across and to the center of the top of, the framework 172, where the water line 114 is attached to a set of nozzles 174, which are directed downward into the housing 24 and onto the scrap A on the conveyor belt 22. The nozzles 174 disperse high pressure water from the water line 114 onto the scrap A as shown.

As can be seen from the drawings and readily understood by one of ordinary skill in the art, Aluminum feed material or scrap A, which is ready for the delacquering process, can be controllably sprayed with water by the nozzles 174 of the spray subassembly 120 just prior to the scrap A being inserted into the material feed chute 16 for the rotary kiln 12. In addition, the nozzle 154 of the heating duct water injector subassembly 118 can spray atomized water into the duct 60 of the burner subassembly 18, thereby controllably adding moisture into the heated gases entering the discharge port 42 of the kiln 12.

A user-programmable computer control system (“CCS”, not shown) operates each of the operative components of the cooling system 100, including a number of the various water and air flow sensors, flow valves and regulators, the pump 110, and the heating elements 108. In addition, the CCS is operatively linked to various sensors in various locations throughout the furnace 10, including in the kiln 12, that provide the CCS with operational conditions throughout the furnace 10 and the kiln 12. The CCS can therefore be programmed to allow the user to selectively control the temperature, timing, volume and flow intensity of the atomized water being injected into the kiln 12—via the conveyor spray subassembly 120, through the heating duct water injector subassembly 118, or both-in response to the operational conditions in the furnace 10 and the kiln 12.

It is anticipated that the novel scrap metal furnace evaporative cooling system 100 may, for example, be operated, at least in one general representative method, as follows:

At low volatile content:
a. No water spray
b. Afterburner temperature controlled by burner fire
c. O₂ content controlled by O₂ blower control
d. Temperature at kiln inlet controlled by diverter damper

At medium volatile content:
a. Increase AB temperature to allow a second control range (set 50 F higher in calculation), control AB temperature by diverter damper (burner will be at minimum due to volatiles)
b. O₂ control by O₂ blower control (same)
c. Kiln inlet temperature switched to control by water spray

At high volatile content:
a. AB temperature control by diverter damper
b. O₂ control by O₂ blower control (same)
c. Kiln inlet temperature control by water spray

U.S. Pat. No. 11,520,360 to Novelis Inc., of Atlanta, GA (the “360 Patent”) discloses a water spray cooling system for a rotary kiln scrap metal decoating/delacquering furnace with a recirculation subassembly. The two water sprayers disclosed in the 360 Patent are located: (i) in the afterburner; and (ii) in the heating duct for the kiln just upstream of the kiln, but downstream from the juncture of the afterburner duct and the recirculation duct. It has been learned by Applicants that the 360 Patent suffers from several shortcomings overcome by the present invention.

First, adding water in the afterburner imparts several heat and temperature control problems. That is, an afterburner is traditionally sized to generate a desired resonance time for its heat profile. But adding water changes this resonance time, and can the entire heat balance of the furnace system. Further, adding water in the afterburner can create unpredictable “cold spots” in the afterburner. Such “cold spots” are very difficult to quantify and control, which in turn adversely impacts the operational control of heat and temperature in the kiln, downstream from the afterburner.

Applicants have found that “wetting” the scrap A that is run through the kiln 12 prior to placing the scrap A in the kiln 12 allows the added moisture to release relatively gradually as the scrap A tumbles through the kiln 12. This results in a relatively uniform distribution of cooling in the kiln 12 that is more controllable, as compared to injecting water in the afterburner, as disclosed in the 360 Patent.

With regard to the 360 Patent injection of coolant/water into the duct just upstream of the kiln, Applicants have learned that the resonance time of the atomized water in the duct can play a significant role in ability to control the heat and temperature in the kiln. That is, if the resonance time is too short, blocks of cooled gases and/or excess moisture can enter the kiln and impart chaos into the kiln's heat and temperature profiles, resulting in limitations on operational control. Thus, it has been found to be desirable to maintain as long a resonance time for the water/moisture injected into the hot gas stream entering the kiln as reasonably possible to allow time for the moisture to create a uniform cooling of the hot gases. Thus, Applicants' configuration, which positions the subassembly 118 in the duct 60 upstream of the juncture between the duct 57 and the duct 60, distances the subassembly 118 substantially further from the kiln 12 than that disclosed in the 360 Patent so as to lengthen the resonance time for the atomized water injected by the subassembly 118.

It should also be noted that the 360 Patent requires measuring and controlling coolant pressure to regulate the coolant spray system. In contrast, the system disclosed here is configured with control loops that regulate flow through the coolant/water spray subsystem nozzles based upon coolant/water flow rates—i.e., not based upon coolant (e.g., water) pressure.

While we have described in the detailed description a configuration that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel scrap metal furnace evaporative cooling system 100 for a metal recycle furnace 10 of the present invention can be arranged in a number of other and related varieties of configurations without expanding beyond the scope of our invention as set forth in the claims.

By way of example, the evaporative cooling system 100 need not be configured to include both nozzles 174 and 154, and their associated injectors and water lines. Rather, the cooling system 100 can be configured to only include one of these two sets of water lines and nozzles.

By way of further example, the nozzles 174 and 154 need not be positioned nor oriented exactly as depicted in the Figures. That is, for example, the nozzle 154 can be positioned at other locations in the duct 60, while one or more of the nozzles 174 can be positioned at various locations along the feed conveyor 14.

In addition, the evaporative cooling system 100 may be configured such that any one or more of the system's components can be operated manually.

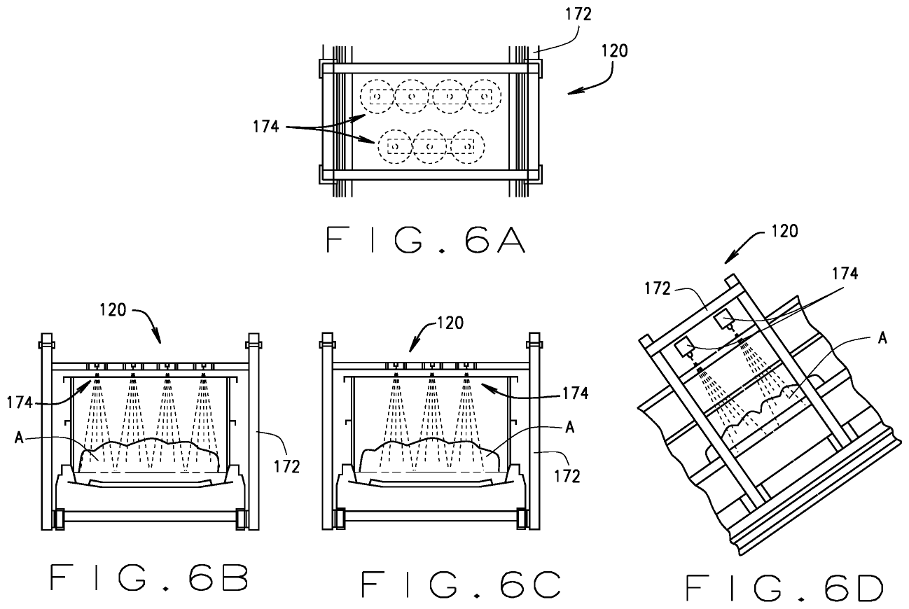

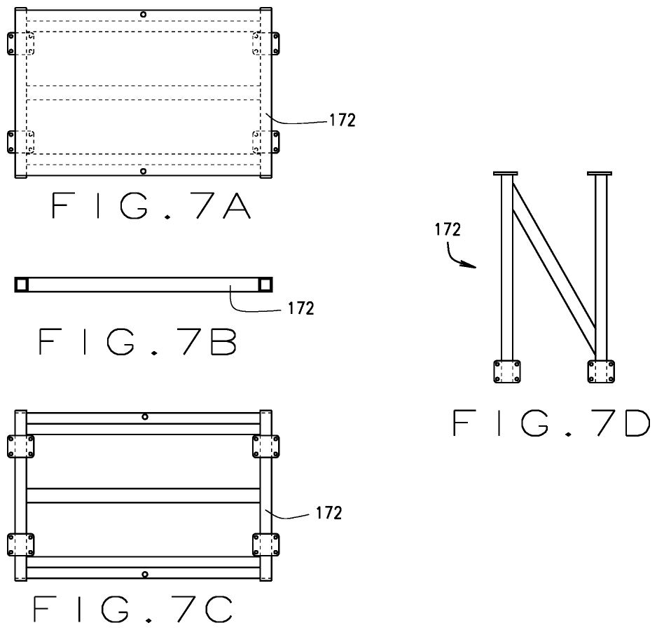

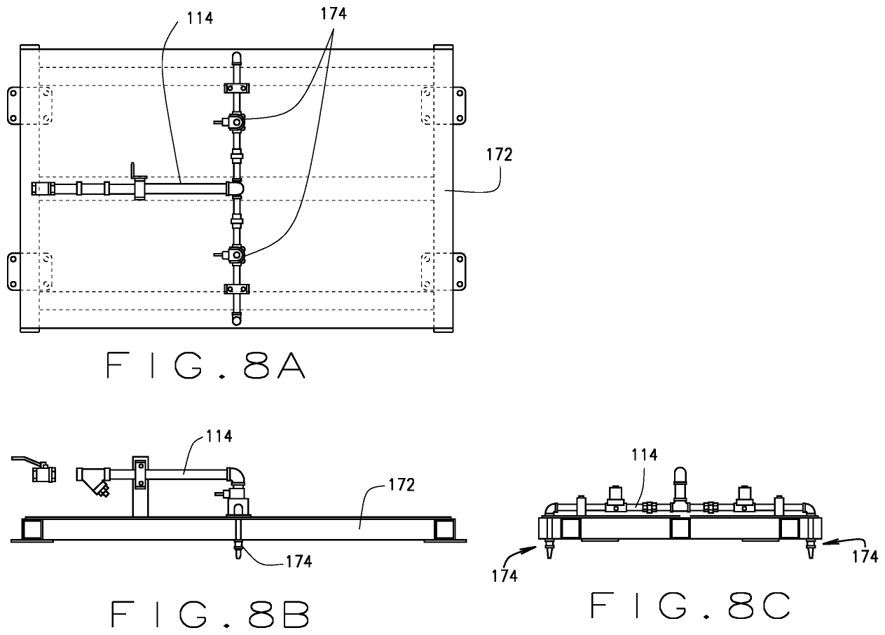

Moreover, the evaporative cooling system 100 may be configured to include various water and/or gas valves, flow controllers, pumps, and sensors that are not depicted or included in the embodiment of FIGS. 1-9 described above. Each such component can be operatively connected to the CCU to provide automated control over the component. The precise numbers, locations and configurations of each of these components will depend upon the specific configuration of the furnace, the specific processes to be used in the furnace, and the degree of control desired for the furnace by using the system 100.

It is also recognized by the Applicants that the furnace 10 may be fitted with only one of the atomizing water injector subassembly 118 and conveyor spray subassembly 120, or both. Further, each of these subassemblies 118 and 120 can be configured to have its own water supply line (such as the water line 102), and its own water heater (such as the hot water tank 106). Further, the furnace 10 may be fitted with more than one such subassembly 118 or 120, or those subassemblies may include a differing number of nozzles than depicted in the Figures. That is, the subassembly 118 may have two or more nozzles, while the subassembly 120 may have more or less than the seven nozzles shown.

Also, while the subassembly 118 includes an atomizing injection nozzle 154, it is recognized that the subassembly 118 can function with a non-atomizing nozzle. Conversely, while the subassembly 120 does not include an atomizing injection nozzle, it is recognized that the subassembly 120 can function with an atomizing nozzle.

While the water pump 110 is depicted positioned upstream of the water tank 106, one or more such water pumps can alternatively be positioned at any point along any one or more of the water lines 102, 109, 111, 112 and/or 114.

It is also not required that the water lines 102, 109, 111, 112 and/or 114 have the specific cross-sectional size as described. Rather, each of these water lines can have a greater or smaller diameter, so long as they enable the system 100 to operate properly.

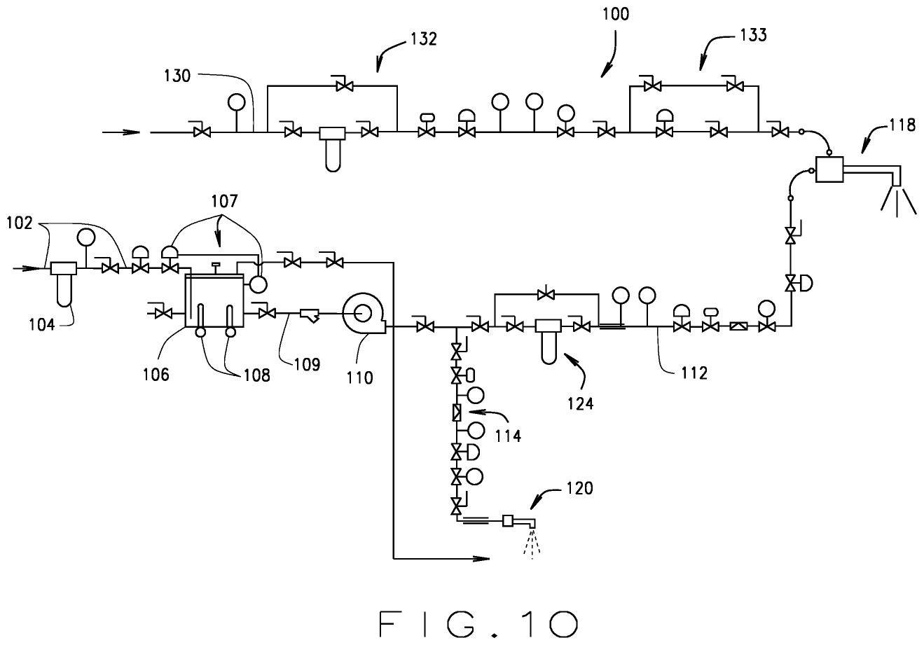

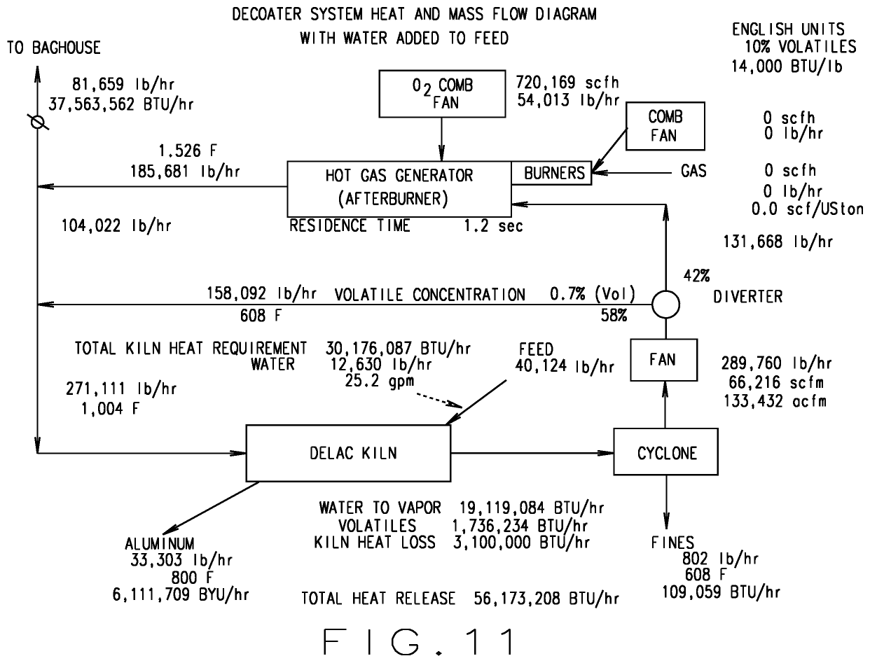

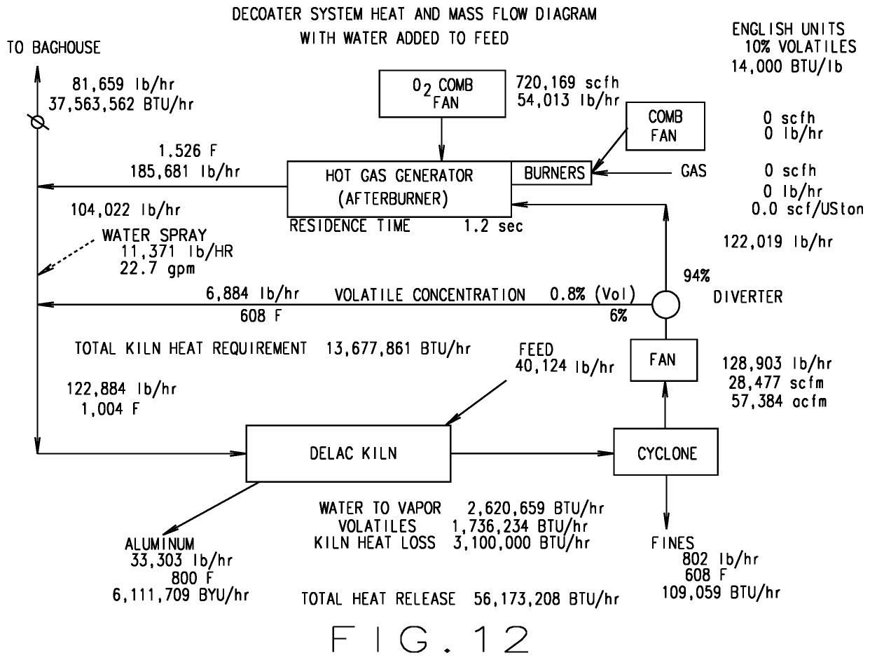

In addition, as can be seen by the alternate configuration of the system 100 depicted in FIG. 10, numerous differing water and air valves, sensors, regulators and pumps can be positioned and used at various junctures along the water lines 102, 109, 111, 112 and/or 114, and along the air line 130. Any one or more of these can be operatively associated with the CCU to allow for automated operation of each such component.

Although the system 100 is shown incorporated into a furnace 10 that has a rotary kiln 12 with its hot gasses injected proximate the discharge port 42 of the kiln 12 and exhaust gases are collected from the kiln proximate the charge port 40 of the kiln 12, the system 100 can also be readily adapt to various other furnace configurations, including for example furnaces with stationary kilns or with a rotary kiln having hot gasses injected into the kiln proximate the kiln's charge port with exhaust gases being collected from the kiln proximate the kiln's discharge port.

It is also recognized that the system 100 may utilize a coolant other than water, including for example, various gases and inert liquids. Similarly, instead of using pressurized air to atomize the coolant, the system 100 may use any variety of gasses, and particularly inert gases such as for example Nitrogen or Helium.

Additional variations or modifications to the configuration of the above-described novel scrap metal furnace evaporative cooling system 100 for a metal recycle furnace 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of our invention.

What is claimed is:

1. An evaporative cooling system for a scrap metal delacquering furnace, said furnace having a rotary kiln, said rotary kiln having a first end and a second end opposite said first end, said rotary kiln having a charge port proximate said first end for the introduction of scrap metal into said rotary kiln and a discharge port proximate said second end for removal of said scrap metal from said rotary kiln, said furnace having an afterburner and a first duct in communication with said afterburner, said afterburner generating hot gases, said first duct directing at least a portion of said hot gases from said afterburner into a collective supply duct, said collective supply duct directing said portion of said hot gases into one of said charge port and said discharge port, said furnace having an exhaust gas recycle subassembly and a diverter valve, said recycle subassembly collecting exhaust gases from one of said charge port and said discharge port, and directing said exhaust gases through said diverter valve, said diverter valve selectively dividing said exhaust gases into a first portion directed through a second duct into said collective supply duct and a second portion directed through a third duct into said afterburner, said evaporative cooling system comprising:
a. a first water line, said first water line being connected to and receiving pressurized water from a pressurized water source; and
b. a first water spray subassembly, said first water spray subassembly being connected to and receiving pressurized water from said first water line, said first water spray subassembly being positioned proximate said first duct of said furnace, said first water spray subassembly comprising a first water nozzle, said first water nozzle being positioned at least in part in said first duct and oriented to direct water from said first water line into said first duct.

2. The evaporative cooling system of claim 1, wherein said first water nozzle at least in part atomizes said water directed through said nozzle into said first duct.

3. The evaporative cooling system of claim 1, further comprising a second water spray subassembly, and wherein said furnace further comprises a conveyor, said conveyor comprising a first end and a second end, said conveyor moving scrap metal from said first end where said scrap metal is loaded onto said conveyor to said second end at which said scrap metal is urged into said kiln charge port, said second water spray subassembly being positioned proximate said conveyor, said second water spray subassembly receiving pressurized water and directing said pressurized water toward said scrap metal positioned on said conveyor.

4. The evaporative cooling system of claim 3, wherein said second water spray subassembly has a second nozzle, said second nozzle being oriented proximate said furnace conveyor to direct water from said first water line toward said scrap metal positioned on said conveyor.

5. The evaporative cooling system of claim 3, further comprising a second water line, said second water line being connected to and receiving pressurized water from a pressurized water source, one of said first said second water lines providing pressurized water to said second water spray subassembly.

6. The evaporative cooling system of claim 1, further comprising one of a first adjustable water valve, a first water flow controller, and a first water pump, said first adjustable water valve being positioned in said first water line to regulate the flow of water in said first water line, said first water flow controller being positioned in said first water line to regulate the flow of water in said first water line, said first water pump being positioned in said first water line and controllably increasing the flow of water in said first water line, wherein adjusting the operation of one of said first adjustable water valve and said first water flow controller and said first water pump controls a flow of water in said first water line to said first water spray subassembly.

7. The evaporative cooling system of claim 6, further comprising a user-programmable computer control system, said computer control system manipulating one of said first adjustable water valve, said first water flow controller, and said first water pump, to automatically control said flow of water to said first water spray subassembly.

8. The evaporative cooling system of claim 7, further comprising a first water flow sensor positioned at least in part in said first water line and operatively associated with said computer control system, said first water flow sensor generating an electronic signal indicative of the flow of water in said first water line and communicating said electronic signal to said computer control system.

9. The evaporative cooling system of claim 7, further comprising a first temperature sensor positioned proximate one of said rotary kiln and said exhaust gas recycle subassembly and said afterburner, said first temperature sensor being operatively associated with said computer control system, said first temperature sensor generating an electronic signal indicative of the temperature in one of said rotary kiln and said exhaust gas recycle subassembly and said afterburner and communicating said electronic signal to said computer control system, said computer control system automatically regulating at least one of said first water valve and said first water flow controller and said first water pump in response to said electronic signal.

10. The evaporative cooling system of claim 1, further comprising a water heater in operative communication with said first water line, and a temperature control subassembly, said water heater heating water in said first water line to a predetermined temperature said temperature control subassembly automatically adjusting the temperature of water heated by said water heater to said predetermined temperature.

11. An evaporative cooling system for a scrap metal delacquering furnace, said furnace having a rotary kiln, said rotary kiln having a first end and a second end opposite said first end, said rotary kiln having a charge port proximate said first end for the introduction of scrap metal into said rotary kiln and a discharge port proximate said second end for removal of said scrap metal from said rotary kiln, said furnace having a material feed conveyor, said conveyor transporting scrap metal to said kiln charge port, said evaporative cooling system comprising:
a. a first water line, said first water line being connected to and receiving pressurized water from a pressurized water source; and
b. a first water spray subassembly, said first water spray subassembly connected to and receiving pressurized water from said first water line, said first water spray subassembly being positioned proximate said furnace conveyor, said first water spray assembly, said first water spray subassembly being positioned proximate said furnace conveyor and oriented to direct water toward said scrap metal positioned on said conveyor.

12. The evaporative cooling system of claim 11, wherein said furnace further comprises an afterburner and a first duct, said afterburner generating hot gases, said first duct directing at least a portion of said hot gases from said afterburner into a collective supply duct, said collective supply duct directing said portion of said hot gases into one of said charge port and said discharge port, said furnace having an exhaust gas recycle subassembly and a diverter valve, said recycle subassembly collecting exhaust gases from one of said charge port and said discharge port, and directing said exhaust gases through said diverter valve, said diverter valve selectively dividing said exhaust gases into a first portion directed through a second duct into said collective supply duct and a second portion directed through a third duct into said afterburner, said evaporative cooling system comprising:
a. a second water spray subassembly, said first water spray subassembly being connected to and receiving pressurized water, said second water spray subassembly being positioned proximate said first duct of said furnace, said first water spray subassembly comprising a first water nozzle, said first water nozzle being positioned at least in part in said first duct and oriented to direct pressurized water said first duct.

13. The evaporative cooling system of claim 12, wherein said first water nozzle at least in part atomizes said water directed through said nozzle into said first duct.

14. The evaporative cooling system of claim 12, further comprising a second water line, said second water line being connected to and receiving pressurized water from a pressurized water source, one of said first said second water lines providing pressurized water to said second water spray subassembly.

15. The evaporative cooling system of claim 12, further comprising one of a first adjustable water valve, a first water flow controller, and a first water pump, said first adjustable water valve being positioned in said first water line to regulate the flow of water in said first water line, said first water flow controller being positioned in said first water line to regulate the flow of water in said first water line, said first water pump being positioned in said first water line and controllably increasing the flow of water in said first water line, wherein adjusting the operation of one of said first adjustable water valve and said first water flow controller and said first water pump controls a flow of water in said first water line to said first water spray subassembly.

16. The evaporative cooling system of claim 15, further comprising a user-programmable computer control system, said computer control system manipulating one of first adjustable water valve, said first water flow controller, and said first water pump, to automatically control said flow of water to said first water spray subassembly.

17. The evaporative cooling system of claim 16, further comprising a first water flow sensor positioned at least in part in said first water line and operatively associated with said computer control system, said first water flow sensor generating an electronic signal indicative of the flow of water in said first water line and communicating said electronic signal to said computer control system.

18. The evaporative cooling system of claim 16, further comprising a first temperature sensor positioned proximate one of said rotary kiln and said exhaust gas recycle subassembly and said afterburner, said first temperature sensor being operatively associated with said computer control system, said first temperature sensor generating an electronic signal indicative of the temperature in one of said rotary kiln and said exhaust gas recycle subassembly and said afterburner and communicating said electronic signal to said computer control system, said computer control system automatically regulating at least one of said first water valve and said first water flow controller and said first water pump in response to said electronic signal.

19. The evaporative cooling system of claim 11, further comprising a water heater in operative communication with said first water line, and a temperature control subassembly, said water heater heating water in said first water line to a predetermined temperature said temperature control subassembly automatically adjusting the temperature of water heated by said water heater to said predetermined temperature.

20. The evaporative cooling system of claim 11, wherein said first water spray subassembly has a nozzle, said nozzle being oriented proximate said furnace conveyor to direct water toward said scrap metal positioned on said conveyor.
